(19) United States
(12) Patent Application Publication
(10) Pub. No.: US 2003/0061723 A1
(43) Pub. Date: Apr. 3, 2003

(54) Roofing tool and method of using same

(76) Inventor: Robert W. Sellers, Henderson, NV (US)

Correspondence Address: Quirk & Tratos, Suite 500 North, 3773 Howard Hughes Parkway, Las Vegas, NV, 89109, US

(21) Appl. No.: 09/879,233

(22) Filed: Jun. 11, 2001

(51) Int. Cl. G01D 21/00

(52) U.S. Cl. 33/648

(57) ABSTRACT

A roofing tool and method of using same is disclosed. Said tool eliminates safety concerns and reduces the time to shingle a mansard. The tool includes a handle, means for gripping a shingle, one or more elongated members, and alignment fixtures for accurately attaching shingles. A roofer applies pressure to an upper grip of the handle traversing a control rod in the direction of the handle rotating control arms connected to an upper jaw of the gripping means. The roofer places a shingle between the upper jaw and a lower jaw and releases the pressure upon the handle. Said pressure release causes, by means of a tension spring, the upper jaw to compress upon the shingle and lower jaw securing the shingle. Alignment tabs and stops insure the shingle and tool are aligned respectively. A method of using the tool includes a catch apparatus and elongated hammering tool.

### FIELD OF INVENTION

This invention is in the general field of roofing and, more particularly, is a tool permitting a user to attach shingles safely, accurately and efficiently, to the lower level of a mansard or the like. A method of using the tool to shingle a mansard is further disclosed.

### DESCRIPTION OF THE PRIOR ART

Tools applicable to roofing have been utilized for centuries and have been granted patent protection in the United States as early as the year 1866. Roofing, namely attaching shingles to a roof, has never been a glorious endeavor but still technological advances are necessary to render the skill safe, accurate and efficient.

A mansard is a difficult structure to attach shingles. The difficulty is especially evident regarding the lower level of the mansard. A mansard overhangs, at a steep angle, the roof and upper section of a home or building. The combination of the steep angle and the nearly uniform mansard length of four feet along its face complicates the attachment of shingles to the mansard's lower level.

Roofers normally erect scaffolding systems, use ladders or repel the mansard in order to attach shingles along the lower level of the mansard. Each of these commonly used procedures for shingling the lower level of a mansard are time-consuming and extremely dangerous. Several issued patents are directed to alternative systems for shingling a roof. None of the issued patents is directed to shingling the lower level of a mansard specifically, but nonetheless, the patents provide a general nature of the prior art.

U.S. Pat. No. 710,281 (the '281 patent) discloses a Shingling Carriage and Gage designed to securely attach to a roof surface and support a roofer in a sitting position. The roofer is then able to attach shingles while able to maneuver about the roof. Such a system requires a great amount of time to install, requires an experienced user and is wholly unsafe. The '281 patent system is not applicable to the steep face of a mansard.

U.S. Pat. No. 5,197,257 (the '257 patent) discloses an Apparatus for Applying Shingles to a Roof. The benefit of the '257 apparatus is that it obviates the need for alignment chalk lines used to insure proper alignment of shingles. The '257 apparatus is complicated in comparison to applicant's tool and is not applicable for use on the steep face of a mansard.

U.S. Pat. Nos. 786,710 (the '710 patent) and 5,526,577 (the '577 patent) disclose an Adjustable Shingling Gage and a Shingling Device, respectively. Although over ninety-years separates the two inventions, they are similar in design. Both inventions require elaborate structural designs be erected on the roof. Both the '710 patent and '577 patent claim inventions which are time-consuming and complex. While the '710 and '577 inventions may be applicable to a mansard, it would be a dangerous arrangement for the roofer.

Applicant's invention permits the user to immediately begin attaching new shingles upon removal of old shingles without the need for inefficient structural arrangements. Beyond ease of operation, applicant's invention is completely safe to operate.

### SUMMARY OF THE INVENTION

An object of the present invention is to minimize the time required to shingle a mansard or the like.

Another object of the present invention is to eliminate the safety risks associated with shingling a mansard or the like.

Yet another object of the present invention is to accurately align shingles to a mansard or the like.

Yet another object of the present invention is to provide an efficient, safe and accurate method of shingling a mansard or the like from removal of old shingles to attachment of new shingles.

Yet another object of the present invention is to provide a method of shingling a mansard from start to finish.

According to the present invention, a roofing tool for attaching shingles to a mansard or the like is provided. The roofing tool includes a handle, means for securely gripping the shingle, an elongated member able to reach the lower level of a mansard from a rooftop and alignment fixtures for accurately attaching the shingles.

In the preferred embodiment an upper grip and a first end of lower rod form a handle. Said upper grip is rotatably connected to a control rod and rotatably connected to the lower rod adjacent a first end. The first end of the lower rod forms a lower grip. The control rod and lower rod extend parallel to ends opposite the handle and affix to a shingle gripping means.

An upper jaw and a static lower jaw form the shingle gripping means for the shingles. Two L-shaped control arms join the upper jaw, the control rod and the lower rod. First ends of the control arms connect to an upper surface of the upper jaw and second ends rotatably connect to the control rod. Hubs of the control arms are rotatably connected to the lower rod. Applying pressure to the upper grip in the direction of the lower grip traverses the control rod in the direction of the handle rotating the control arms clockwise separating the upper jaw from the lower jaw. The separation permits a shingle to be placed and secured between the upper jaw and lower jaw.

A tension spring is biased between the control arms and a spring stop connected to an upper surface of the lower rod adjacent the shingle gripping means. Said applied pressure to the upper grip rotates the control arms which compress the spring and upon release of the upper grip the tension spring forces the upper jaw to an original position atop the lower jaw securely holding the shingle in place.

Tool alignment stops fixed on an underside of the lower rod near the handle and shingle alignment tabs protruding from an upper surface of the lower jaw permit the user to quickly align the tool and at least a first and second row of shingles being attached to a mansard.

Other objects, features, and advantages of the invention will become apparent to those skilled in the art upon consideration of the following detailed description of the preferred embodiments thereof as illustrated in the accompanying drawings.

### BRIEF DESCRIPTION OF THE DRAWINGS

FIG. 1 is a side view of the present invention;

FIG. 2 is a top view of the present invention;

FIG. 3 is a side view of the present invention with the elongated support member removed to show the control rod and lower rod in more detail;

FIG. 4 is a side view of the present invention as used in connection with a mansard;

FIG. 5 is a perspective view of the present invention as used in connection with a mansard depicting the invention aligning a lowest most shingle and thereafter a second lowest shingle;

FIG. 6 is perspective view of a catch apparatus utilized in the method of shingling a mansard;

FIG. 7 is a side view of the catch apparatus;

FIG. 8 is a top view of a rectangular plate used to hold a tool alignment stop in place;

FIG. 9 is a side view of a rectangular plate used to hold a tool alignment stop in place;

FIG. 10 is a side view of a control arm.

### DESCRIPTION OF THE EMBODIMENTS

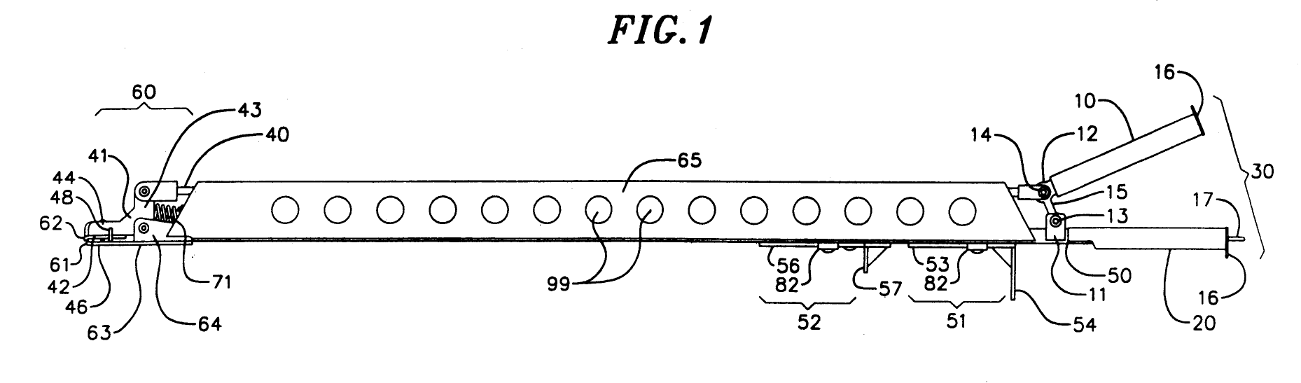

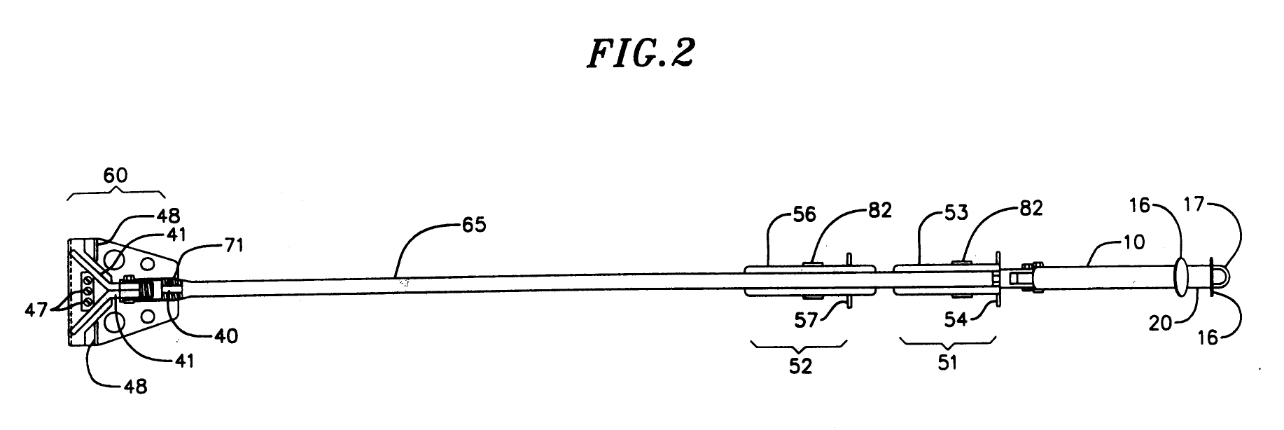

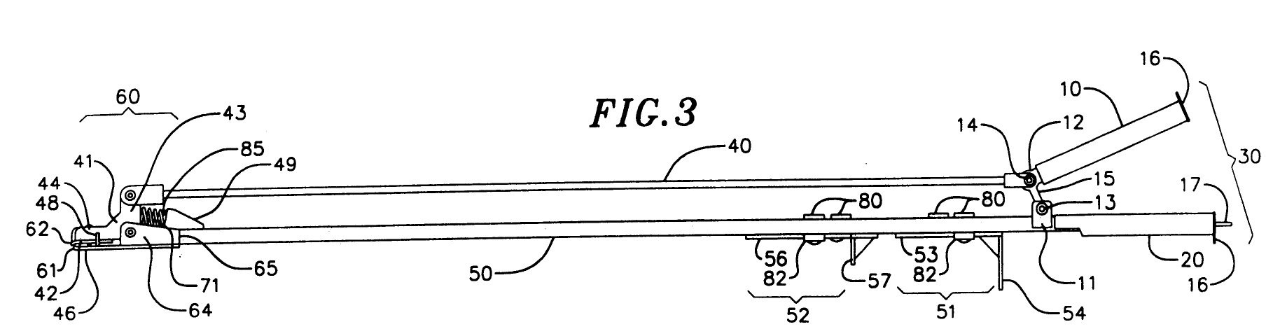

As shown in FIGS. 1, 2 and 3 a roofing tool comprises an upper grip 10 and a lower grip 20 forming a handle 30. An elongated control rod 40 and an elongated lower static rod 50 support a shingle gripping means 60 opposite said handle 30. Said lower grip 20 is defined by a first end of the lower rod 50 opposite the gripping means 60.

Said upper grip 10 is rotatably connected to said control rod 40 and rotatably connected to said lower rod 50 adjacent the lower grip 20. Two handle pivot brackets 11 are rigidly attached to opposite sides of the lower rod 50 adjacent the lower grip 20. An L-shaped belcrank 12 includes a first pivot point 13, aligned planarly to a second pivot point 14 forming one leg, and a second leg 15. The first pivot point 13 is rotatably attached to the handle pivot bracket 11, the second pivot point 14 is rotatably connected to an end of the control rod 40 and the second leg 15 is rigidly inserted into the upper grip 10. The dual connection arrangement permits the upper grip 10 to move, when pressured, in the direction of the lower grip 20 traversing the control rod 40 in the direction of the handle 30.

The upper grip 10 and the lower grip 20 each integrate end caps 16 which prevent a roofer's hands from slipping off the tool during use. The lower grip 20 further integrates a U-shaped member 17 rigidly attached to end cap 16 for attaching the tool to a first end of a safety strap (not shown), a second end of the safety strap is attached to the roofer or any fixed structure.

Control rod 40 and lower rod 50 extend parallel from the handle 30 to opposite ends affixed to a shingle gripping means 60. Now also referring to FIG. 10, two control arms 41 connect the control rod 40, the lower rod 50 and an upper jaw 42. The control arms 41 include a vertical branch 43 and a horizontal branch 44 said horizontal branch 44 extends angularly from the vertical branch 43. The horizontal branch 44 of the control arms 41 connect to an upper surface of the upper jaw 42 at remote points. The vertical branch 43 of the control arms 41 rotatably connect to the control rod 40. Said control arms 41 rotatably connect to the lower rod 50 at the hub of their vertical branch 43 and horizontal branch 44.

Two pivot brackets 64 connect a lower static jaw 46 to the lower rod 50. Lower edges 63 of the pivot brackets 64 connect to an upper surface of the lower jaw 46. Adjacent perpendicular edges 65 of the pivot brackets 64 connect to opposite sides of the lower rod 50. Separation of the upper jaw 42 from the lower static jaw 46 is accomplished by applying pressure, by means of one hand, to the upper grip 10 traversing the control rod 40 in the direction of the handle 30 rotating the control arms 41 in a clockwise direction about the pivot brackets 64.

A compressed tension spring 71 is securely recessed between, and communicates with, the vertical branches 43 of the control arms 41 and a spring stop 49 connected to an upper surface of the lower rod 50 adjacent the shingle gripping means 60 and partially disposed between the pivot brackets 64. A first end of the tension spring 71 encompasses vertical branch flanges 45 and a second end encompasses a spring stop spool 85. The tension spring 71 is held in place by the constant natural expansive forces along the length of the spring 71. The tension spring 71 is further compressed upon application of pressure to the upper grip 10. When said pressure is released said tension spring 71 forces the upper jaw 42 to compress on a shingle and hold it in place between the upper jaw 42 and the lower jaw 46.

Threaded apertures in the upper jaw 42 receive screws 47 which communicate with an upper surface of the shingle reinforcing the tool's grip on the shingle. The upper jaw 42 and lower jaw 46 include opposed flared ends 61, 62. Said flared ends 61, 62 compliment the shingle gripping ability of the jaws 42, 46 and the screws 47. A lower surface of the upper jaw 42 and a upper surface of the lower jaw 46 include scored portions adjacent the flared ends 61, 62. Said scored portions communicate with the shingle providing a final means of securely gripping the shingle. Said lower jaw 46 includes two shingle alignment tabs 48 which extend vertically and insure the shingle is properly aligned for attachment. A first tool alignment stop 51 and a second tool alignment stop 52 connected to the lower rod 50 adjacent the handle 30 insure the roofing tool is aligned during shingle attachment. The first tool alignment stop 51 is used to attach the lowest row of shingles to a mansard and the second tool alignment stop 52 is used to attach the second lowest row of shingles to the mansard.

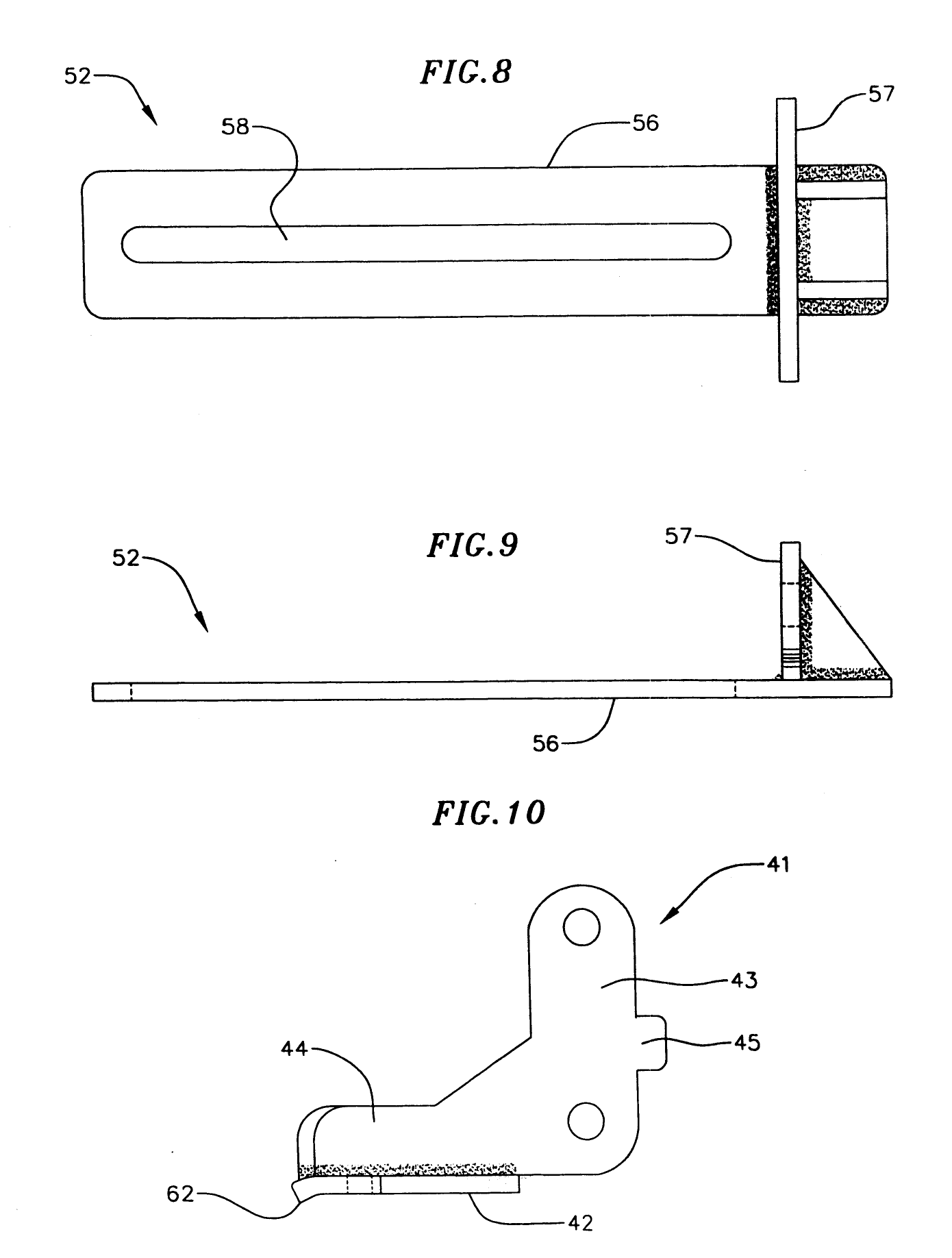

Now also referring to FIGS. 8 and 9 the first alignment stop 51 is comprised of a first rectangular plate 53 and a stop 54 connected perpendicularly. Superimposed within said rectangular plate 53 is a first elliptical void 55 for receipt of an adjustable attachment means to the lower rod 50. Similar, the second alignment stop 52 is comprised of a second rectangular plate 56 and stop 57 connected perpendicularly. Superimposed within the second rectangular plate 56 is a second elliptical void 58 for receipt of an adjustable attachment means to the lower rod 50. Said second stop 57 is shorter in length than the first stop 54 providing a proper tool angle allowing the shingle to be placed in communication with the mansard regardless of the stop being utilized.

Said adjustable attachment means is comprised of two pairs of threaded inserts 80, one pair for each alignment stop 51,52, bored through the lower rod 50 at points adjacent the lower grip 20. The elliptical voids 55,58 of the rectangular plates 53,56 are each aligned with one pair of threaded inserts 80 and attached by means of screws extended through holes in clamps 82, enveloping the rectangular plates 53,56, extending through the voids 55, 58 and inserted into the threaded inserts 80. The clamps 82 discourage separation of the voids 55,58. The arrangement permits the screws to be loosened and the stops adjusted for attachment of standard shingles or metric shingles as required.

An elongated support member 65 houses both the control rod 40 and the lower rod 50. The support member 65 arches radially about the control rod 40 and lower edges 63, 64 rigidly attach to opposing sides of the static lower rod 50. The support member 65 provides the tool with stability over its length and protects the control rod 40 and the lower rod 50 from potential damage. Voids 99 present in the support member 65 are provided to decrease the overall weight of the tool. Other components of the tool may be similarly provided with weight lightening voids.

FIG. 4 shows a side view of the roofing tool during use. The first tool alignment stop 51 is abutted to the upper most point of the mansard permitting the lowest row of shingles to be attached. Once the lowest row of shingles is attached, the roofing tool is raised until the second tool alignment stop 52 is abutted to the upper most point of the mansard permitting the second lowest row of shingles to be attached.

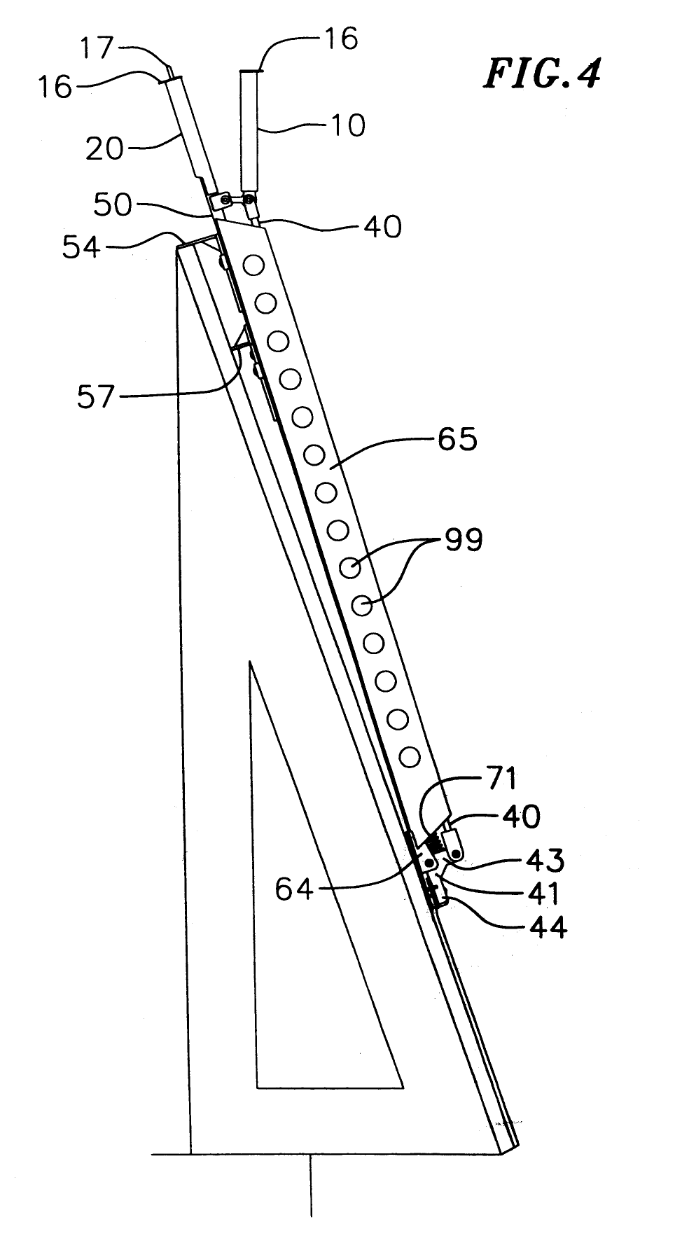

FIG. 5 shows a perspective view of the roofing tool and shingles during attachment of a lowest row of shingles and a second lowest row of shingles.

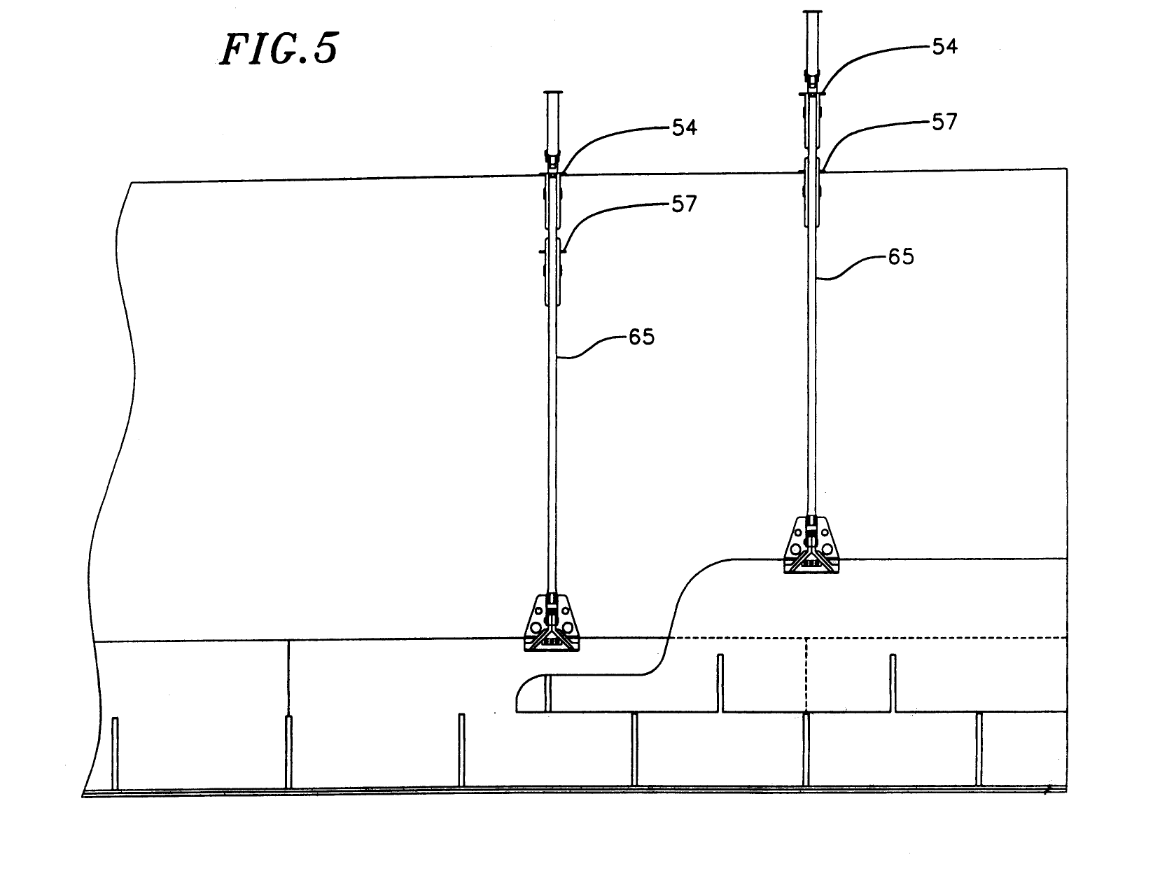

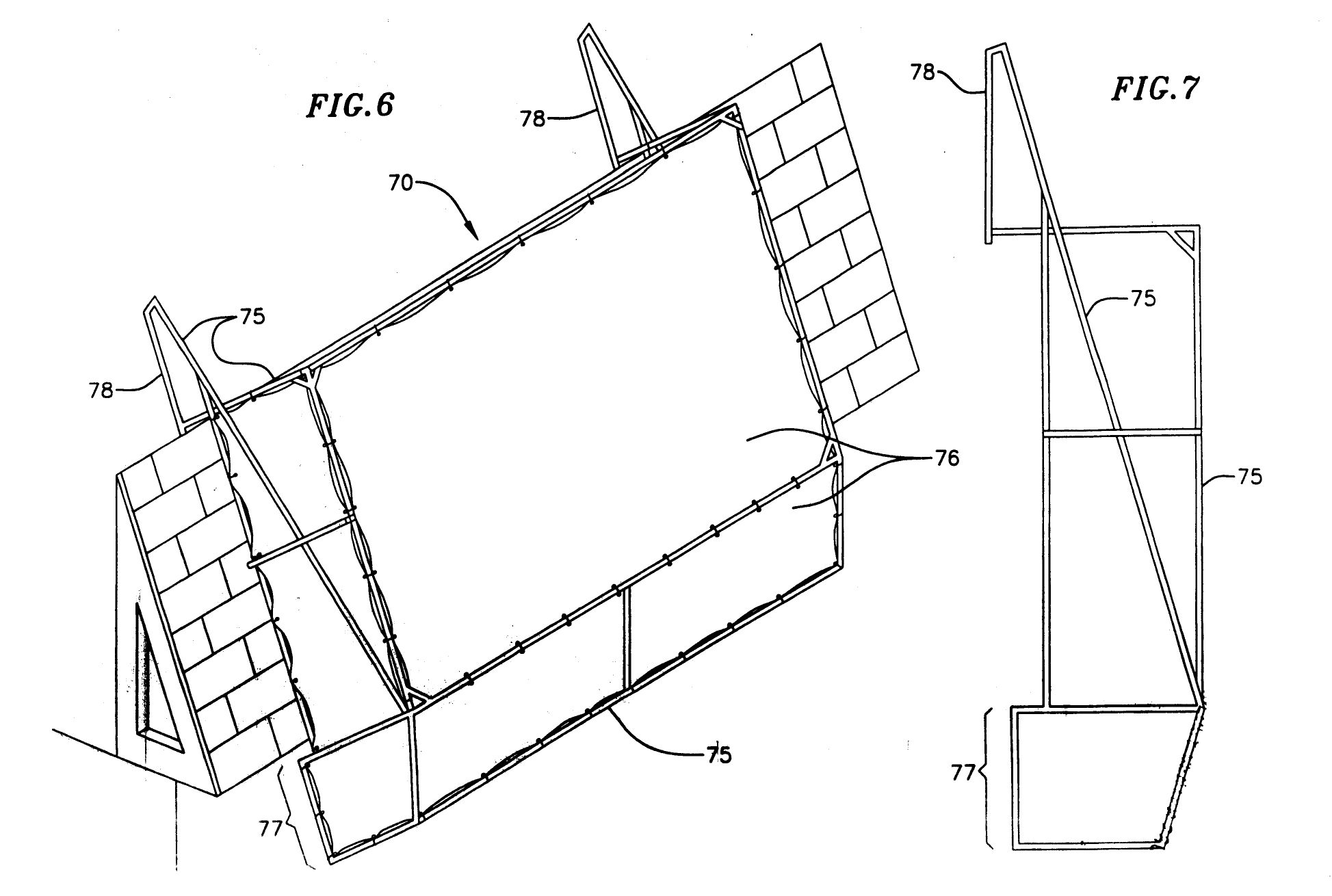

FIG. 6 shows a catch apparatus used in a method of roofing a mansard. Said method of shingling a mansard includes:

a means for removing old shingles (not shown);

a catch apparatus;

a roofing tool as disclosed herein;

an elongated hammering tool (not shown);

shingles; and

at least one roofer (not shown).

A roofer removes shingles from a mansard using known roofing tools compelling said shingles to fall into the catch apparatus 70 removably positioned to the mansard at a specific work location. The catch apparatus 70 can be relocated quickly by the roofer while the roofer remains on the roof. The catch apparatus 70 removes the necessity of a large container on the ground for catching the falling shingle debris. The drawbacks of the large container including difficulty in re-positioning it along the ground continually, destruction of plants, flowers, shrubs, etc., and the inherent risk of dropping shingle debris from an elevated position are overcome by the catch apparatus 70.

The catch apparatus 70 includes a frame 75 and a flexible lining material 76. In a preferred embodiment said lining material 76 is attached to the frame 75 by means of nylon plastic ties or zip ties. Said frame 75 is designed to hang on the mansard at the specific work location. The catch apparatus 70 further includes a basket portion 77 extending the length of a lower level of the catch apparatus. The catch apparatus includes one or more upper members 78 that hang and secure said catch apparatus in position. The basket portion 77 rests below a lower level of the mansard permitting all removed shingles to drop easily into the basket portion 77. The catch apparatus 70 is pulled onto the roof when full and emptied into a more permanent refuse container.

Upon removal of the old shingles the roofer, or assistant, positions and partially inserts several nails, at desired locations, in the shingle. The roofer then squeezes the handle 30 of the roofing tool with one hand separating the upper jaw 42 from the lower static jaw 46 and a shingle is placed between the separated jaws 42,46 until an upper end of the shingle abuts the alignment tabs 48 insuring the shingle is aligned properly whereby the handle is released closing the upper jaw 42 upon the shingle and the lower jaw 46. Once the jaws 42,46 have been closed, screws 47 communicate with the shingle reinforcing the tool's grip of the shingle between the jaws 42,46. When necessary, the screws can be tightened to further guarantee a firm grip on the shingle.

The roofer next leans over the roof and the mansard aligning the roofing tool by means of the tool alignment stops 51,52. The first tool alignment stop 51 is used to attach the lower row of shingles to a mansard and the second tool alignment stop 52 is used to attach the second lowest row of shingles to the mansard. An elongated 5 hammering tool is used to impact and drive in the pre-positioned nails attaching the shingle to the mansard.

The method described herein greatly reduces the time and labor required to complete the shingling of a mansard or the like. More important, the roofing tool eliminates the safety risks of current roofing tools and methods.

In the preferred embodiment the tool is manufactured of steel or other hardened metal to provide the utmost stability and durability. Further, in the preferred embodiment the rigid connections referred to herein are accomplished by welds and the rotatable connections are accomplished by hardened shoulder bolts 94 and clevises 95. However, those skilled in the art will recognize that other connection means, including rotatable connections, can be accomplished by various other means without departing from the scope of the present invention.

Although the invention has been described in detail with reference to a preferred embodiment, additional variations and modifications exist within the scope and spirit of the invention as described and defined in the following claims.

I claim:

1. A roofing tool including:
an upper grip and a lower grip forming a handle, said upper grip connected to a control rod and a lower rod;
a means for gripping connected to the control rod and the lower rod at ends opposite the handle.

2. The roofing tool of claim 1 wherein the upper grip is rotatably connected to the control rod and the lower rod.

3. The roofing tool of claim 1 wherein the lower grip is a first end of the lower rod.

4. The roofing tool of claim 1 wherein the means for gripping includes one or more control arms rotatably connected to the control rod and the lower rod, said one or more control arms further connected to an upper jaw, a lower jaw is connected to the lower rod so that the upper jaw and lower jaw are aligned, a tension spring disposed between the control arms and a spring stop forces the upper jaw to compress upon the lower jaw.

5. The roofing tool of claim 4 wherein the upper jaw and the lower jaw include opposed flared ends.

6. The roofing tool of claim 5 wherein the lower jaw includes alignment tabs.

7. The roofing tool of claim 5 wherein the upper jaw includes one or more threaded apertures for insertion of screws.

8. The roofing tool of claim 1 further including a support member housing the control rod and the lower rod, said support member arches radially about the control rod and two lower edges of the support member connect to opposing sides of the lower rod.

9. The roofing tool of claim 1 wherein the upper grip and lower grip include end caps greater in diameter than the upper grip and lower grip.

10. The roofing tool of claim 9 wherein the lower grip end cap includes a U-shaped member for attachment of a safety strap.

11. The roofing tool of claim 1 wherein the control rod and lower rod are of sufficient length to permit a shingle to reach the lower edge of a mansard.

12. A roofing tool including:
an upper grip and a lower grip forming a handle, said upper grip rotatably connected to a control rod and a lower rod;
a means for gripping connected to the control rod and the lower rod at ends opposite the handle;
one or more alignment stops connected to the lower rod.

13. The roofing tool of claim 12 wherein the one or more alignment stops are connected to the lower rod adjacent the handle.

14. The roofing tool of claim 13 wherein the one or more alignment stops are adjustable.

15. The roofing tool of claim 14 wherein a first alignment stop nearest the handle is longer than a second alignment stop further distance from the handle.

16. The roofing tool of claim 12 wherein the means for gripping includes one or more control arms rotatably connected to the control rod and the lower rod, said one or more control arms further connected to an upper jaw, a lower jaw is connected to the lower rod so that the upper jaw and lower jaw are aligned, a tension spring disposed between the control arms and a spring stop forces the upper jaw to compress upon the lower jaw.

17. The roofing tool of claim 16 wherein the upper jaw and the lower jaw include opposed flared ends.

18. The roofing tool of claim 17 wherein the lower jaw includes alignment tabs.

19. The roofing tool of claim 17 wherein the upper jaw includes one or more threaded apertures for insertion of screws.

20. A method of attaching the lowest most row of shingles to a mansard using the roofing tool of claim 19 comprising the steps of:
removing old shingles into a catch apparatus;
pre-setting one or more nails in a shingle;
pre-setting the screws to an appropriate depth;
setting the tool alignment stops to accommodate a standard or metric shingle;
applying pressure to the upper grip thereby separating the upper jaw from the lower jaw;
placing the shingle between the upper jaw and lower jaw aligning the shingle with the alignment tabs and releasing the pressure upon the upper grip;
abutting a first alignment stop to an upper edge of the mansard;
nailing the pre-set nails into the mansard using a elongated hammering tool.

21. The method of claim 20 wherein a second alignment stop is abutted to the upper edge of the mansard to attach a second lowest row of shingles to the mansard.

22. The method of claim 20 wherein the catch apparatus includes a frame covered in a flexible material, said catch apparatus hangs by the frame from an upper level of the mansard, said catch apparatus further includes a basket portion extending the length of a lower level of the catch apparatus such that the basket portion rests below a lower level of the mansard.

23. The catch apparatus of claim 22 wherein the frame includes one or more upper members that hang on the upper edge of the mansard and secure said catch apparatus in position.
